(19) United States
(12) Patent Application Publication
(10) Pub. No.: US 2003/0121005 A1
(43) Pub. Date: Jun. 26, 2003

(54) Archiving and retrieving data objects

(76) Inventors: Axel Herbst, Eppingen (DE); Gerd Buchmuller, Ostringen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/323,336

(22) Filed: Dec. 18, 2002

Related U.S. Application Data
(63) Continuation-in-part of application No. 10/281,287, filed on Oct. 25, 2002, now abandoned.

(30) Foreign Application Priority Data
Dec. 20, 2001 (EP) 01130276.7

(51) Int. Cl. G06F 15/00

(52) U.S. Cl. 715/513

(57) ABSTRACT

Methods, systems, and computer programs for archiving and retrieving data objects. For archiving, data objects are one-to-one converted to markup objects. Each markup object represents the data items of the corresponding data object. The markup objects are concatenated to a single data structure that is byte addressable. Object identification is indexed to addresses of the data structure for each markup object. Retrieving is performed in inverse order. Further features include using XML, coding numerical items by characters, character set code identification, compressing and expanding, and adding index and semantic descriptor to the structure.

### CROSS-REFERENCE TO RELATED APPLICATION

This application is a continuation-in-part application of and claims priority to U.S. application Ser. No. 10/281,287, filed on Oct. 25, 2002, which is hereby incorporated by reference herein for all purposes.

### CLAIM FOR PRIORITY UNDER 35 U.S.C. §119

A claim for priority is made under the provisions of 35 U.S.C. §119 for the present U.S. patent application based upon European Patent Application Serial No. EP 01130276.7, filed on Dec. 20, 2001.

### BACKGROUND

The present invention relates to data processing by digital computer, and more particularly to computer systems, programs, and methods for archiving and retrieving data objects.

Public and private organizations such as companies and universities access data by computers that implement applications, databases and archives. Data is usually structured and represented by data objects. For example, a company can store business documents such as orders and invoices that have separate representations for address, product, currency, or monetary amount.

Generally, applications write and read data objects to and from a database. Due to huge amounts of data that are often generated, archiving tools copy selected data from databases to long-term digital archives. Long-term refers to a term measured in months, years or decades. The archiving tools are typically part of the application.

Data selection for archiving purposes has a variety of well-known aspects. For example, a tool generally archives data objects for closed business transactions but leaves data objects for ongoing business transactions in the database. During an archiving session, the tools archive sets of data objects rather than archiving single data objects. Sets are commonly archived as files. For minimizing communication and storage overhead, administrators optimize the file size.

During the archiving term, the application, the archive, and its management software can be subjected to various and often non-coordinated modifications, including but not limited to updating, upgrading, replacing, migrating to different platforms or operating systems, changing character-codes, changing numeric codes, switching media, modernizing programming or retrieval languages, and so on. Despite ongoing changes in the application and archive tools, archived data must be preserved and information loss must be prevented. Information is lost when data or metadata is lost or corrupted. After an initial application writes a data object to an initial archive, the following later scenarios all present technical challenges: (1) a modified application retrieving the same data object from the initial database, (2) a modified application retrieving objects from a modified archive, or (3) the initial application retrieving objects from a modified archive. Occasionally, the modified application is completely different from the initial one and is reduced to a retrieving tool.

Turning to data retrieving (as the complement to archiving), the application or any other retrieving tool (“requester”) needs to locate individual data objects and read them from the archive within a time frame constrained by two conditions: (1) the time required to read from the medium (i.e., latency and transfer rate); and the maximum time allowed by the retrieving tool (and the person-using the retrieving tool). Further, data objects should be retrieved without superfluous data that causes undesired costs in terms of time, memory, bandwidth and so on.

These and other well known requirements to archiving are often referred to by terms such as readability, platform independence, format independence, medium independence, data transfer efficiency, interpretability and random access. Electronic archiving data objects is discussed in a variety of publications, such as, for example, Schaarschmidt, Ralf: “Archivierung in Datenbanksystemen”. Teubner. Reihe Wirtschaftsinformatik. B. G. Teubner Stuttgart, Leipzig, Wiesbaden. 2001. ISBN 3-519-00325-2; Herbst, Axel: “Anwendungsorientiertes DB-Archivieren”. Springer Verlag Berlin Heidelberg New York 1997. ISBN 3-540-63209-3; Schaarschmidt, Ralf; Röder, Wolfgang: “Datenbankbasiertes Archivieren im SAP System R/3”. Wirtschaftsinformatik 39 (1997) 5, pages 469-477; and Jürgen Gulbins, Markus Seyfried, Hans Strack-Zimmermann: “Dokumenten-Management”, Springer Berlin 1998. ISBN 3-540-61595-4.

### SUMMARY OF THE INVENTION

The present invention provides complementary methods, systems, and programs for archiving and retrieving data objects. For archiving, a computer converts the data objects into markup objects, concatenates the markup objects to a data structure, namely a single byte addressable file, and indexes object identification information to addresses for each markup object. Retrieving is performed essentially in the opposite order with corresponding steps of looking up, reading, and converting.

Various embodiments of the invention can include different features to ensure interpretability, such as the use of extensible mark-up language (XML), coding numerical items by characters, and identifying the character set code (e.g., code identification or Management Information Base (MIBenum)). Another feature can include using compression and expansion techniques on the data, for instance, compressing markup objects to compressed objects, and expanding the compressed objects back to markup objects, while considering length identification. Yet another feature can include adding an index and a semantic descriptor to the data structure. The semantic descriptor can include a descriptor, a document type definition file (DTD), or XML schema.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 illustrates a simplified block diagram of an archiving and retrieving tool.

FIG. 2 illustrates a simplified memory with memory portions and data structure (DS).

FIG. 3 illustrates an exemplary data object.

FIG. 4 illustrates an exemplary markup object.

FIG. 5 illustrates an exemplary compressed object.

FIG. 6 illustrates a data structure with concatenated markup objects.

FIG. 7 illustrates the data structure with concatenated compressed objects.

FIG. 8 illustrates an overview for an archiving method by showing data objects, markup objects, the data structure, and an index.

FIG. 9 illustrates a flowchart for the archiving method.

FIG. 10 illustrates a flowchart for a retrieving method.

FIG. 11 illustrates a hierarchy of a data table with exemplary data objects, as well as illustrates an XML-file for the complete table and the index.

Like reference symbols in the various drawings indicate like elements.

### DETAILED DESCRIPTION

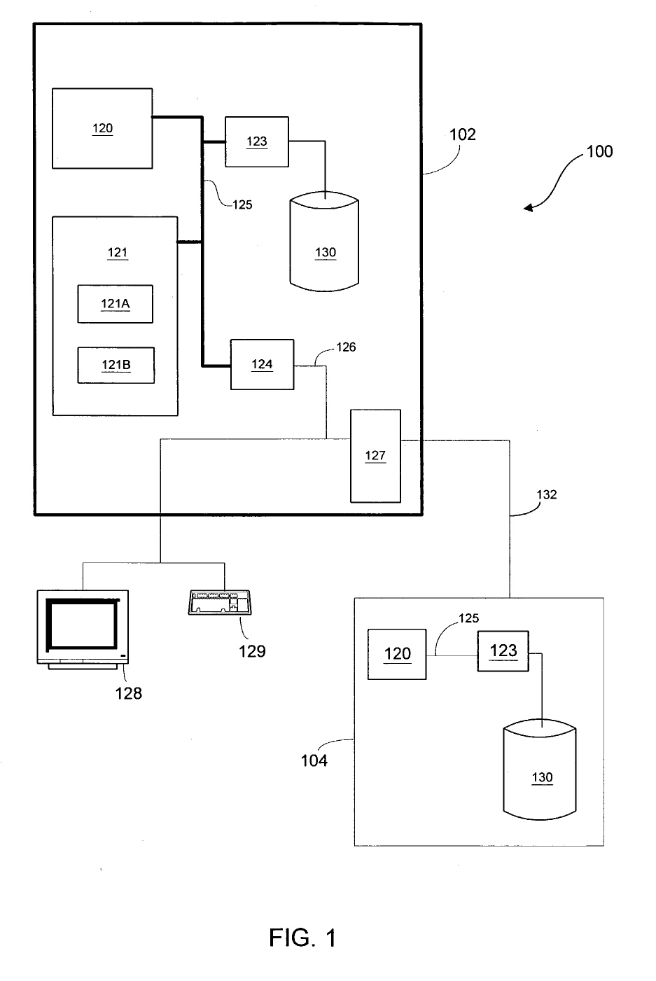

FIG. 1 illustrates a block diagram of an archiving and retrieving tool 100 suitable for implementing apparatus or performing methods in accordance with the invention. Tool 100 of FIG. 1 includes application computer 102 and archive computer 104. Application computer 102 includes a processor 120, a memory 121, a hard drive controller 123, and an input/output (I/O) controller 124 coupled by a processor (CPU) bus 125. Memory 121 can include a random access memory (RAM) 121A, and a program memory 121B, for example, a writable read-only memory (ROM) such as a flash ROM. Application computer 102 can be preprogrammed, in ROM, for example, or it can be programmed (and reprogrammed) by loading a program from another source (for example, from a floppy disk, a CD-ROM, or another computer) into a random access memory for execution by the processor. Hard drive controller 123 is coupled to a hard disk 130 suitable for storing executable computer programs, including programs embodying the present invention, and data.

The I/O controller 124 is coupled by means of an I/O bus 126 to an I/O interface 127. The I/O interface 127 receives and transmits data in analog or digital form over communication links 132, e.g., a serial link, local area network, wireless link, or parallel link. Also coupled to the I/O bus 126 is a display 128 and a keyboard 129. Alternatively, separate connections (separate buses) can be used for the I/O interface 127, display 128 and keyboard 129.

Archive computer 104 generally comprises some or all of the same components described above for application computer 102, such as processor 120, hard drive controller 123, CPU bus 125, and hard disk 130. These components are not shown in FIG. 1 for clarity. In alternative implementations, archive computer 104 can include magnet-optical disks, write once, read many (WORM) memory, or other memory or storage systems in lieu of or in addition to hard disk 130. Archive computer 104 can communicate with application computer 102 through I/O interface 127 in analog or digital form using communication links 132 as described above, which include but not limited to a serial link, local area network, wireless link, or parallel link.

Application computer 102 can have both archiving and retrieving functionality, which is explained in further detail herein. Archive computer 104 is primarily used for storing archived data. In alternate embodiments, the methods of the invention can be implemented on other computers as well, or all of the functionality described herein can be performed on a single computer.

As used in this description, “retrieve” refers to reading data objects from an archive, such as archive computer 104; “data object” refers to structured data provided by any computer application; “markup object” refers to a data object represented in markup language; “compressed object” refers to a data object in a compressed format; “descriptor” refers to any schema or scheme that indicates the semantic of the markup language; “file” refers to a data structure with a plurality of addressable bytes; and “byte” refers to the smallest unit of information that is discussed herein, where a byte typically comprises eight bits.

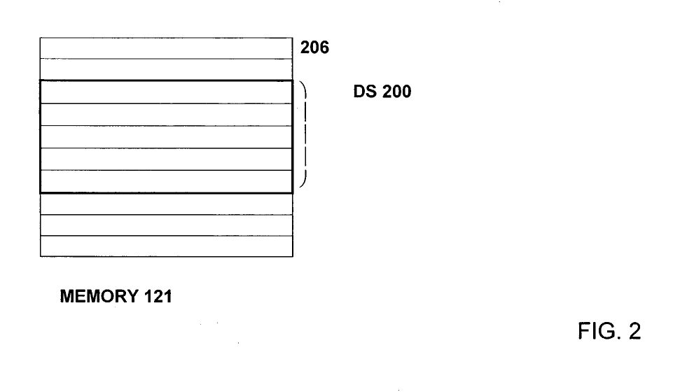

FIG. 2 illustrates a simplified memory 121 with data structure (DS) 200. Memory 121 also has a plurality of byte addressable memory portions 206, represented in FIG. 2 by lines. As indicated by a bold frame, memory 121 can store data structure 200. Data structure 200 is also byte addressable.

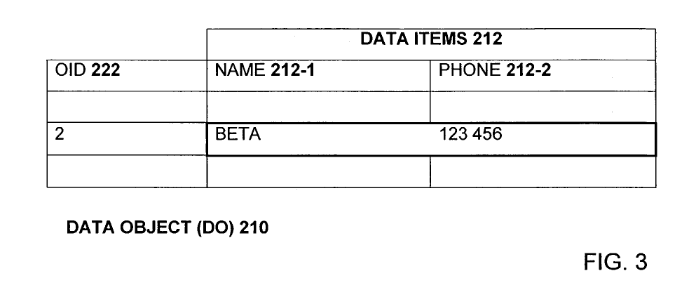

FIG. 3 illustrates an exemplary data object 210. Data object 210 includes data items 212 and is identified by object identification (OID) 222 (e.g., a key). To more clearly demonstrate how a data object functions, examples will be provided where data object 210 is used to store elements of a phone list. It should be noted, however, that these examples are for illustration only and should not be construed as imposing limitations on the invention. In this example, an application computer 102 and archive computer 104 can use a table with “name” and “phone” elements (data items 212-1 and 212-2). Exemplary data object 210 then can be the entry with the name “BETA” in FIG. 3 (item 212-1), and the phone number “123 456” (item 212-2). For clarity, FIG. 3 shows data object 210 using a bold frame. Using explicit object identification 222 is convenient; however, implicit identification is sufficient.

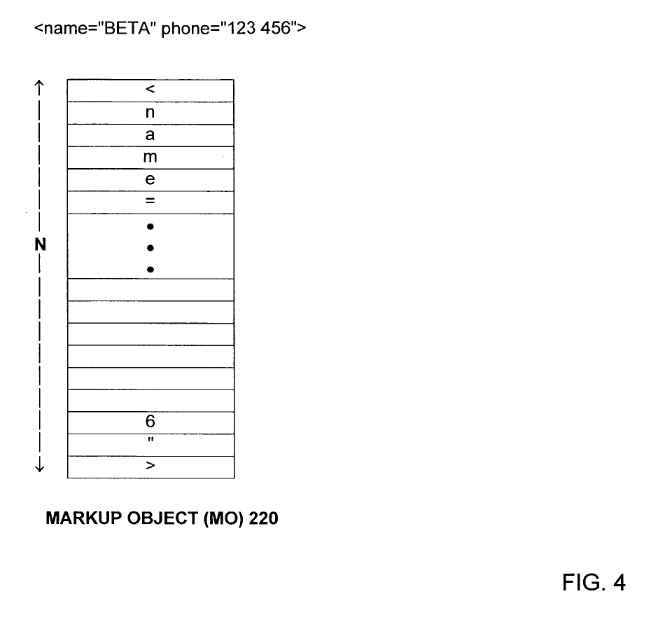

FIG. 4 illustrates an exemplary markup object 220. Markup object 220 represents data items 212 of corresponding data object 210 using a markup language. In other words, markup object 220 has been obtained by one-to-one conversion of item 212-1 (e.g., name) and item 212-2 (e.g., phone number) of data object 210. The markup language used in FIG. 4 is XML. As in the example, the format of the language reads as <name=“BETA” phone=“123 456”>which comprises data items 212 (e.g., “BETA” and “123 456”) and tag identifiers (e.g., <name=“. . .” phone=“. . .”>). FIG. 4 illustrates markup object 220 by bytes with N=30 bytes of information (N represents the number of bytes of information). In an alternative embodiment, the format of the language can use a different form of tag identifiers. E.g., it can read <name>BETA</name>and <phone>123 456</phone>. Still other variations are possible.

The use of markup object 220 allows each data object 210 to be rendered as a self-describing XML document. If data object 210 is rendered as a self-describing XML document, its structure can be determined and its values can be read by widely available XML parsers based on the published and standardized XML syntax. An XML document is syntactically self-explaining, which minimizes information loss. In addition, the implicit schema provided in most XML documents, as well as any available explicit schema, is archived with data object 210. The schema can be formulated as document type definitions (DTD) or written in XML schema. This helps make the semantic interpretation and reuse of the archived data possible.

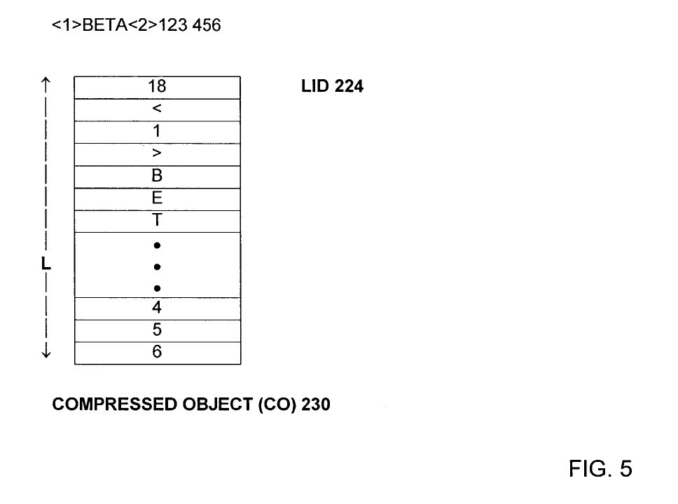

FIG. 5 illustrates an exemplary compressed object 230. In the example shown, the tag identifiers of FIG. 4 have been compressed to <1>and <2>, while data items 212 are not compressed. The number of bytes has been reduced from N=30 to L=18 (where L=length). The first byte indicates length using length identification (LID) 224. In alternative embodiments, alternate compression techniques can be employed, such as Huffmann coding, for example.

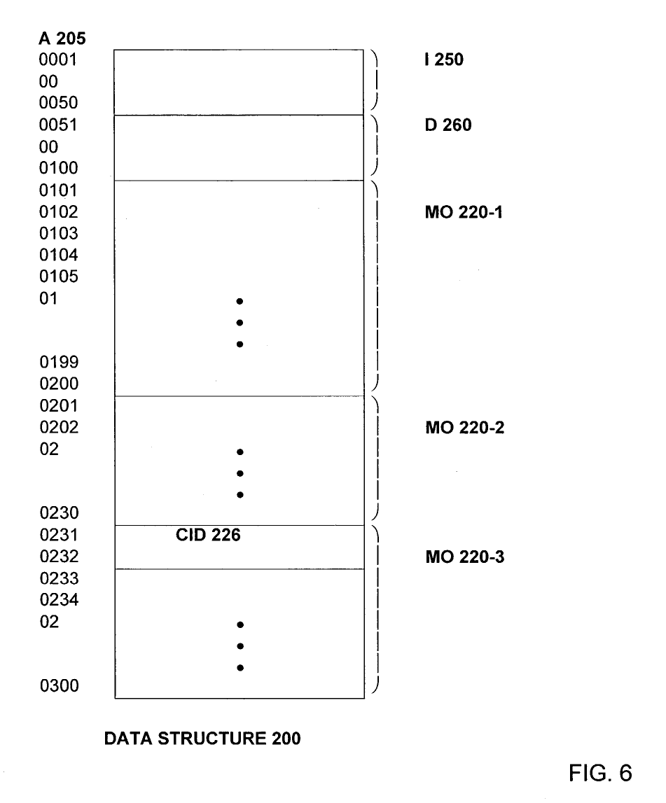

FIG. 6 illustrates data structure 200 with concatenated markup objects (MO) 220-1, 220-2, and 220-3. For clarity, exemplary byte addresses (A) 205 are shown on the left side of FIG. 6. Decimal numbers are used in FIG. 6, although hexadecimal or other number systems can be used as well.

For the example shown in FIG. 6, index (I) 250 and descriptor (D) 260 are stored at addresses 0001 to 0050 and 0051 to 0100, respectively. Markup object 220-1 has N=100 bytes of information and is stored at addresses 0101-0200, markup object 220-2 has N=30 bytes of information and is stored at addresses 0201-0230, and markup object 220-3 has N=70 bytes of information and is stored at addresses 0231-0300. Index 250 comprises a control block for storing these assignments (i.e., which object identification corresponds to which byte address). So for the example used in FIG. 6, object identification “1” (for markup object 220-1) has been indexed to address “0101”, object identification “2” (for markup object 220-2) has been indexed to address “0201”, and object identification “3” (for markup object 220-3) has been indexed to address “0231”. The descriptor represents the semantics of data items 212 in markup objects 220, for example, by stating that the tag identifiers stand for name and phone number.

In some embodiments of the invention, two or more markup objects can be coded by different character sets. Character sets are standardized by well-known organizations, such as the International Organization for Standardization (ISO) and Japan Industrial Standards (JIS), or by various companies. For example, markup objects 220-1 and 220-2 might use Latin, but markup object 220-3 might use Cyrillic (or Greek, or Chinese, or Japanese, or Korean, or Arabic, etc.). FIG. 6 also illustrates that code identification (CID) 226 for markup object 220-3 has been added at addresses 0231-0232.

The invention can distinguish character sets for each object. Code identification 226 can be represented by text or by numbers. The Internet Assigned Numbers Authority (IANA) identifies character sets by unique integer numbers, the so-called “MIBenum” numbers (Management Information Base). The use of such a standard provides advantages because code identification is interpretable without any further information. For example, code identification 226 (for markup object 220-3) is MIBenum “2084”.

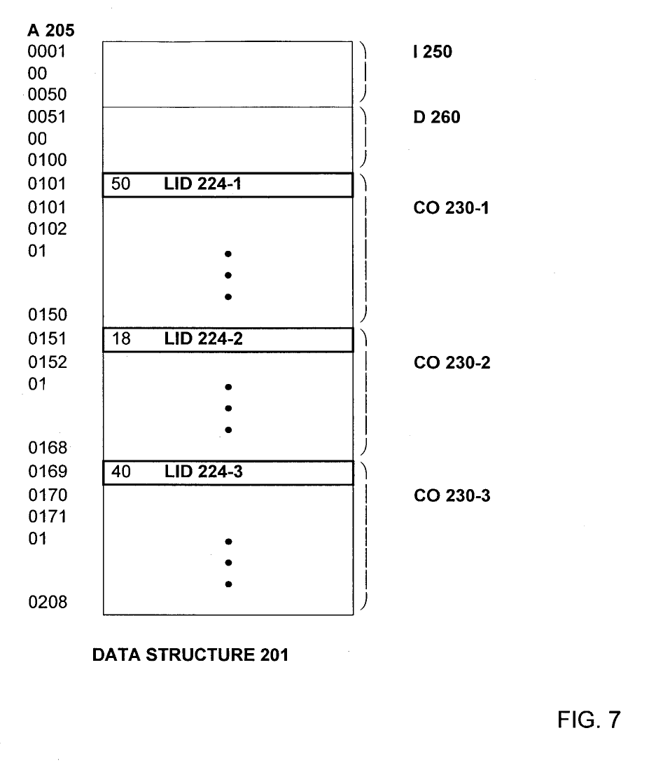

FIG. 7 illustrates a data structure 201 with concatenated compressed objects (CO) 230. Similar to data structure 200 in FIG. 6, data structure 201 is byte addressable. The objects are compressed objects 230, each having length identification (LID) 224 (bold frames). For example, as shown in FIG. 7, markup object 220-1 with N=100 bytes has been compressed to compressed object 230-1 with L=50 bytes, markup object 220-2 with N=30 bytes has been compressed to compressed object 230-2 with L=18 bytes, and markup object 220-3 with N=70 bytes has been compressed to compressed object 230-3 with L=40 bytes. Length identification 224 indicates a value L for each compressed object 230, preferably at the beginning of each compressed object 230. Again for clarity, exemplary byte addresses (A) 205 are shown on the left side of FIG. 7.

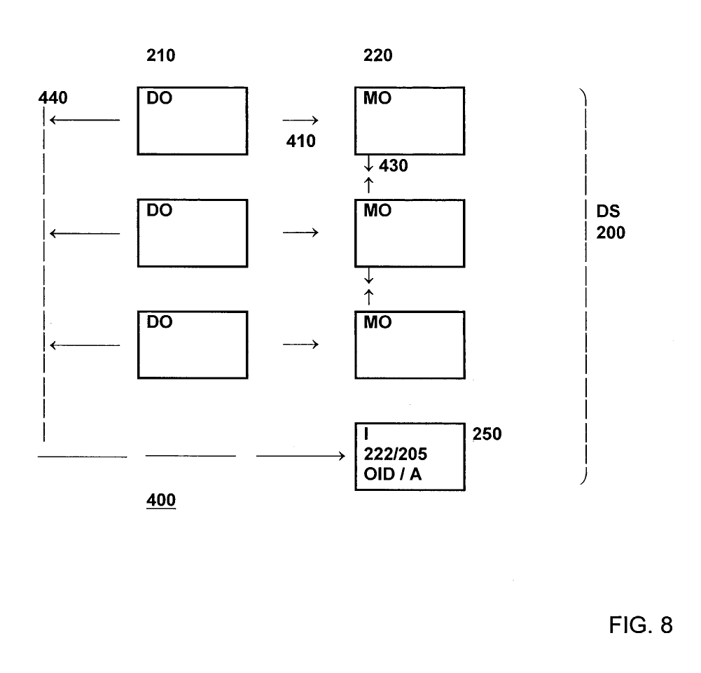

FIG. 8 illustrates an overview for an archiving method 400 using data objects (DO) 210, markup objects (MO) 220, data structure (DS) 200, and index (I) 250. FIG. 8 also includes arrows representing a process for converting data objects 210 into markup objects 220 (step 410), a process for concatenating markup objects 220 into a single data structure 200 that is byte addressable (step 430), and a process for indexing object identification (OID) 222 for each data object 210 to the byte address (A) 205 for data structure 200 (step 440). Index 250 maps object identification 222 with corresponding addresses 205 of data structure 200 for each markup object 220.

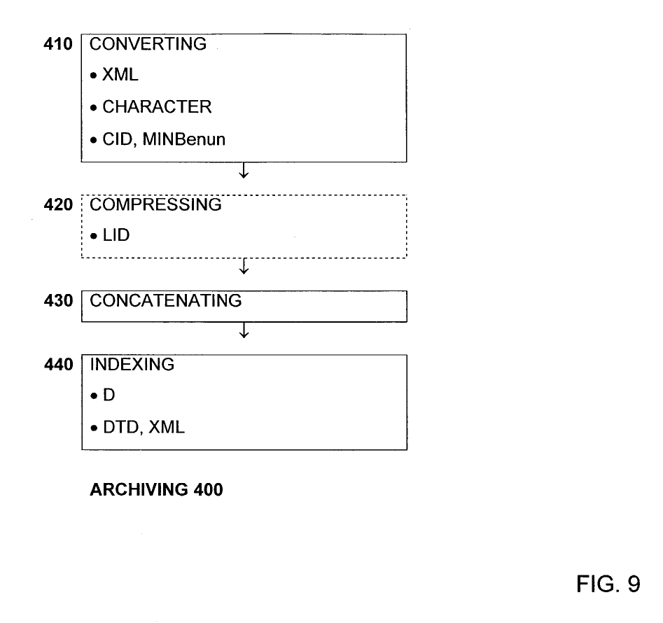

FIG. 9 illustrates a flowchart for one embodiment of archiving method 400. According to this embodiment, method 400 is used for archiving a plurality of data objects and comprises concatenating data objects (i.e., as markup objects) to a byte addressable data structure (step 430), and indexing object identification for each of the data objects to the byte address of the data structure (step 440). Prior to concatenating markup objects into a single data structure that is byte addressable (step 430), method 400 can include a process for converting the plurality of data objects into a plurality of markup objects using one-to-one conversion (step 410), wherein each markup object represents data items of the corresponding data object.

In FIG. 9, useful and desired features are indicated by bullet marks and a dashed frame. In accordance with one embodiment of the invention, during the process for converting data objects into markup objects (step 410), markup objects are provided in extensible markup language (XML) format. In this embodiment, data items are encoded by character code. For example, the real number “2.5” can be coded to a character-only string comprising the character “2”, the “period” character, and the character “5”. Code identification (CID) is added to some or all of the markup objects, and code identification can be represented using MIBenum numbers for character sets defined by IANA.

Following the process for converting data objects into markup objects (step 410), but preceding concatenating markup objects into a single data structure that is byte addressable (step 430), a process for compressing markup objects into compressed objects with length identification (LID) can occur (step 420). Thus, it is compressed objects that are concatenated to a data structure during the concatenating process (step 430).

During the process for indexing object identification for each data object to the byte address for the data structure (step 440), a descriptor (D) can be added to the data structure. The descriptor represents the semantics of data items in markup objects. Preferably, the descriptor is formulated in a document type definition (DTD) schema or in XML schema.

Storing data structures to media is generally performed during or after method 400. The index can be stored in a database separate from the data structures. This approach tends to enhance efficiency. To ensure interpretability, the descriptor should be stored as part of the data structures.

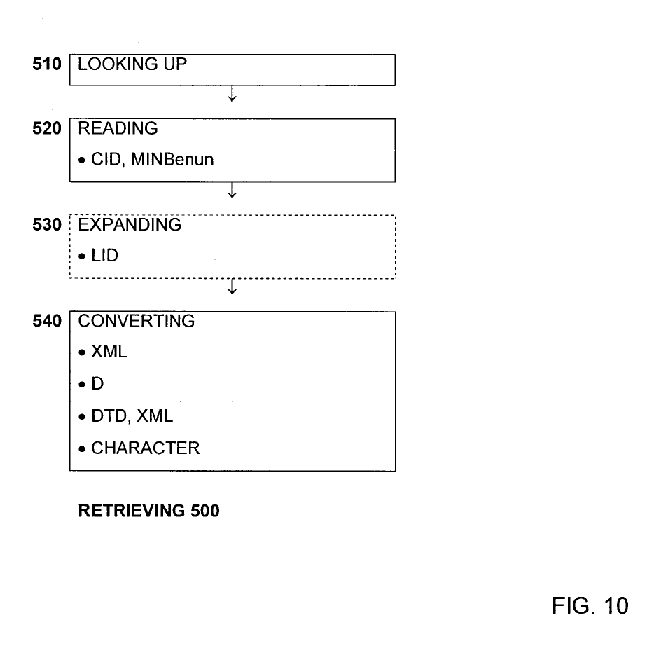

FIG. 10 is a flowchart outlining a data retrieving method 500. Method 500 retrieves a data object from a byte addressable data structure for a given object identification. In one embodiment, method 500 comprises looking up an address, which is generally located within a data structure or a database, where that address corresponds to an object identification (step 510); reading a markup object at the address (step 520); and converting the markup object into a data object, wherein the markup object represents data items of the corresponding data object (step 540).

Method 500 can retrieve data from a data structure. Prior to the converting process (step 540), a compressed object is expanded (step 530) into a markup object by reading a length identification (LID). The length identification discloses the number of bytes (i.e. L bytes) that need to be read to obtain the entire compressed object or markup object. The use of a length identification provides several important advantages. For instance, the up-front knowledge provided by a length identification allows the input/output operation to read as few bytes as possible. In contrast to this, the lack of a length identification often results in an input/output operation having to fetch a predetermined number of bytes, wherein the predetermined number is set to guarantee that the end of the compressed object or markup object will be reached. The use of a length identification also helps when there is data corruption. For example, if bytes within a compressed object or markup object become changed or modified because of deterioration, it can become difficult or impossible to determine where the end of the compressed object or markup object occurs. With a length identification, the system will at least be able to find the beginning of the next compressed object or markup object. The optional features shown for method 500 correspond to the same features discussed above regarding method 400 (e.g., code identification (CID), MIBenum, XML, descriptor, etc.).

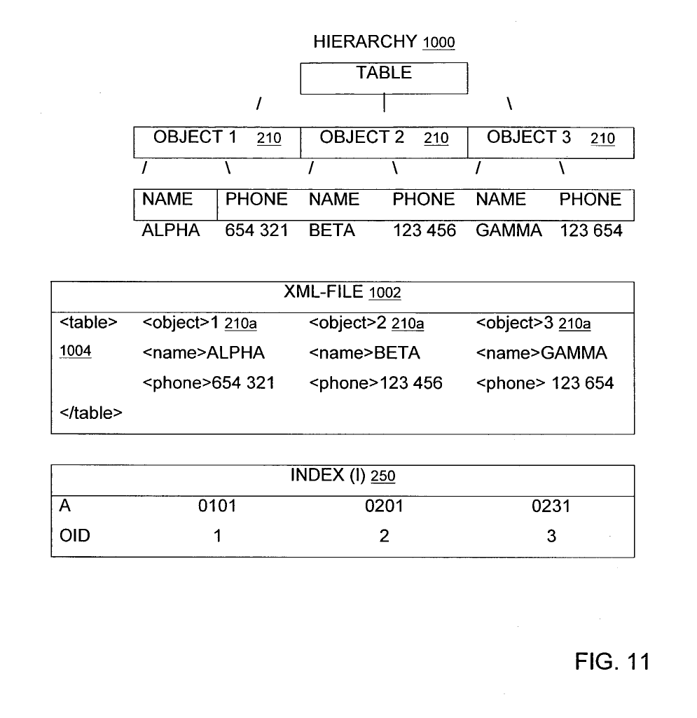

FIG. 11 illustrates a hierarchy 1000 of a data table with exemplary data objects 210 as well as an XML-file 1002 for the complete table and index 250. The data table has three objects 210, each for “name” and “phone”. Below is shown a corresponding XML-file with tags for the complete table 1004 and with object tags 210a for object identification, namely for “name” and for “phone”. For clarity, closing tags (i.e., “</name” tags) and other well-known XML-statements are omitted.

Prior art approaches for archiving XML files and retrieving data items using an XML parser are time consuming. For a given object identification (e.g., object identification 2), the parser would have to search for the object identification tag by reading everything stored in front of the object to be retrieved (i.e., all tags of object 1). In the present invention, retrieving is expedited because the steps of looking up an address in the index (step 5 1 0), reading markup objects from the address (step 520), and converting the markup objects into data objects (step 540) do not require parsing non-relevant objects.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Nevertheless, it will be understood that various modifications may be made without departing from the spirit and scope of the invention. For instance, the steps of the invention can be performed in a different order and still achieve desirable results. Another example is that the present invention can be used for database backup purposes as well. Accordingly, other embodiments are within the scope of the following claims.

What is claimed is:

1. A method for archiving a plurality of data objects comprising:
converting the data objects into a plurality of markup objects, wherein each data object has one or more data items and each markup object represents the data items of the corresponding data object;
concatenating the markup objects into a single data structure that is byte addressable; and
indexing an object identification for each data object to a byte address for the data structure.

2. The method of claim 1, wherein the converting of the data objects into the plurality of markup objects is done by one-to-one conversion.

3. The method of claim 1, wherein the markup objects are provided in extensible markup language-(XML).

4. The method of claim 1, wherein if the data item comprises a numerical data item, then the markup object comprises a character code.

5. The method of claim 1, wherein a code identification is added to the markup objects.

6. The method of claim 5, wherein the code identification is represented by MIBenum numbers for character sets by IANA.

7. The method of claim 1, further comprising compressing the markup objects into one or more compressed objects with a length identification.

8. The method of claim 1, wherein a descriptor is added to the data structure representing semantics of the data items in the markup objects.

9. The method of claim 8, wherein the descriptor is formulated in a document type definition (DTD) schema.

10. The method of claim 8, wherein the descriptor is formulated in an XML schema.

11. A computer system for archiving a plurality of data objects comprising:
means for converting the data objects into a plurality of markup objects, wherein each data object has one or more data items and each markup object represents the data items of the corresponding data object;
means for concatenating the markup objects into a single data structure that is byte addressable; and
means for indexing an object identification for each data object to a byte address for the data structure.

12. The computer system of claim 11, wherein the means for converting the data objects into the plurality of markup objects uses one-to-one conversion.

13. The computer system of claim 11, wherein the means for converting provide the markup objects in extensible markup language (XML).

14. The computer system of claim 11, wherein if the data item comprises a numerical data item, the means for converting encode the numerical data item by a character code.

15. The computer system of claim 11, wherein the means for converting add a code identification to the markup objects.

16. The computer system of claim 15, wherein the means for converting represent the code identification by MIBenum numbers for character sets of IANA.

17. The computer system of claim 11, further comprising means for compressing the markup objects into one or more compressed objects with a length identification.

18. The computer system of claim 11, further comprising means for adding a descriptor to the data structure representing semantics of the data items in the markup objects.

19. The computer system of claim 18, wherein the means for adding a descriptor uses a document type definition (DTD) schema.

20. The computer system of claim 18, wherein the means for adding a descriptor uses an XML schema.

21. A computer program product, tangibly embodied in an information carrier, for archiving a plurality of data objects, the computer program product being operable to cause data processing apparatus to:
convert the data objects into a plurality of markup objects, wherein each data object has one or more data items and each markup object represents the data items of the corresponding data object;
concatenate the markup objects into a single data structure that is byte addressable; and
index an object identification for each data object to a byte address for the data structure.

22. The computer program product of claim 21, wherein the data objects are converted into the plurality of markup objects by one-to-one conversion.

23. The computer program product of claim 21, wherein the instructions for converting cause the processor to provide the markup objects in extensible markup language (XML).

24. The computer program product of claim 21, wherein if the data item comprises a numerical data item, the instructions for converting cause the processor to encode the numerical data item by a character code.

25. The computer program product of claim 21, wherein the instructions for converting cause the processor to add a code identification to the markup objects.

26. The computer program product of claim 25, wherein the instructions for converting cause the processor to represent the code identification by MIBenum numbers for character sets of IANA.

27. The computer program product of claim 21, comprising further instructions operable to cause a processor to compress the markup objects into one or more compressed objects with a length identification.

28. The computer program product of claim 21, comprising further instructions operable to cause a processor to add a descriptor to the data structure representing semantics of the data items in the markup objects.

29. The computer program product of claim 28, wherein the instructions to add a descriptor cause the processor to use a document type definition (DTD) schema.

30. The computer program product of claim 28, wherein the instructions to add a descriptor cause the processor to use an XML schema.

31. A method for retrieving a data object from a byte addressable data structure for a given object identification comprising:
looking up a byte address corresponding to the given object identification;
reading a markup object at the byte address; and
converting the markup object into a data object, wherein the markup object represents one or more data items of the corresponding data object.

32. The method of claim 31, wherein reading a markup object comprises:
retrieving a compressed object and a length identification at the byte address; and
expanding compressed object into the markup object by reading the length identification and reading the compressed object as a number of bytes given by the length identification.

33. A computer system for retrieving a data object from a byte addressable data structure for a given object identification comprising:
means for looking up a byte address corresponding to the given object identification;
means for reading a markup object at the byte address; and
means for converting the markup object into a data object, wherein the markup object represents one or more data items of the corresponding data object.

34. The computer system of claim 33, further comprising:
means for retrieving a compressed object and a length identification at the byte address; and
means for expanding compressed object into the markup object by reading the length identification and reading the compressed object as a number of bytes given by the length identification.

35. A computer program product, tangibly embodied in an information carrier, for retrieving a data object from a byte addressable data structure for a given object identification, the computer program product being operable to cause data processing apparatus to:
look up a byte address corresponding to the given object identification;
read a markup object at the byte address; and
convert the markup object into a data object, wherein the markup object represents one or more data items of the corresponding data object.

36. The computer program product of claim 35, wherein instructions to read a markup object comprise instructions to:
retrieve a compressed object and a length identification at the byte address; and
expand compressed object into the markup object by reading the length identification and reading the compressed object as a number of bytes given by the length identification.
